(19) United States
(12) Patent Application Publication
(10) Pub. No.: US 2016/0088261 A1
(43) Pub. Date: Mar. 24, 2016

(54) SYSTEM AND A METHOD FOR SPECIFYING AN IMAGE CAPTURING UNIT, AND A NON-TRANSITORY COMPUTER READABLE MEDIUM THEREOF

(71) Applicant: KABUSHIKI KAISHA TOSHIBA, Tokyo (JP)

(72) Inventors: Tatsuo KOZAKAYA, Kanagawa-ken (JP); Mayumi YUASA, Tokyo (JP); Osamu YAMAGUCHI, Kanagawa-ken (JP); Masayuki MARUYAMA, Tokyo (JP); Tomokazu KAWAHARA, Kanagawa-ken (JP); Quoc Viet PHAM, Kanagawa-ken (JP)

(21) Appl. No.: 14/858,116

(22) Filed: Sep. 18, 2015

(30) Foreign Application Priority Data
Sep. 24, 2014 (JP) 2014-194489

(51) Int. Cl. H04N 7/18; G06K 9/00; G06K 9/62

(52) U.S. Cl. CPC H04N 7/181; G06K 9/6215; G06K 9/6202; G06K 9/00771; G06K 9/00228

(57) ABSTRACT

According to one embodiment, a system includes a portable device, a plurality of second image capturing units, an extraction unit, a calculation unit, and a specifying unit. The portable device includes a first image capturing unit that captures a first image of a person, and a sending unit that sends the first image. The plurality of second image capturing units captures second images. The extraction unit extracts a first feature of the first image and a second feature of each of the second images. The calculation unit calculates a similarity based on the first feature and the second feature of the each of the second images. If the similarity for a second image is larger than a predetermined threshold, the specifying unit specifies a second image capturing unit that has captured the second image, among the plurality of second image capturing units.

### CROSS-REFERENCE TO RELATED APPLICATION

This application is based upon and claims the benefit of priority from Japanese Patent Application No. 2014-194489, filed on Sep. 24, 2014; the entire contents of which are incorporated herein by reference.

### FIELD

Embodiments described herein relate generally to a system and a method for specifying an image capturing unit, and a non-transitory computer readable medium thereof.

### BACKGROUND

In a surveillance camera system to which many surveillance cameras are connected, in order to confirm a video for a specific surveillance camera, or in order to adjust a parameter such as an angle of view, a device for selecting the surveillance camera is well known.

For example, in the technique disclosed in JP Pub. No. 2009-4977, a position coordinate of a portable device is measured at a plurality of base stations by receiving a radio field intensity from the portable device, and a surveillance camera corresponding to the measured position is selected from a plurality of surveillance cameras. Furthermore, in the video distributing system disclosed in JP Pub. No. 2004-7283, without forcing a user to perform operations (troublesome for the user), a video including the user's desired scene can be acquired and distributed with high resolution.

However, physical positions of all surveillance cameras need to be previously measured and recorded. Furthermore, if these positions cannot be previously measured, a bar code to specify the positional relationship needs to be used.

### BRIEF DESCRIPTION OF THE DRAWINGS

FIG. 1 is a block diagram of an image capturing unit-specifying system according to a first embodiment.

FIG. 2 is a flow chart of processing of the image capturing unit-specifying system according to the first embodiment.

FIG. 3 is a schematic diagram of one example that information is acquired in the image capturing unit-specifying system.

FIG. 4 is a schematic diagram of one example that candidate is selected in the image capturing unit-specifying system.

FIG. 5 is a block diagram of the image capturing unit-specifying system according to a modification of the first embodiment.

FIG. 6 is a block diagram of a hardware component of the image capturing unit-specifying system.

### DETAILED DESCRIPTION

According to one embodiment, an image capturing unit-specifying system includes a portable device, a plurality of second image capturing units, an extraction unit, a calculation unit, and a specifying unit. The portable device includes a first image capturing unit that captures a first image of a person, and a sending unit that sends the first image. The plurality of second image capturing units captures second images. The extraction unit extracts a first feature of the first image and a second feature of each of the second images. The calculation unit calculates a similarity based on the first feature and the second feature of the each of the second images. If the similarity for a second image is larger than a predetermined threshold, the specifying unit specifies a second image capturing unit that has captured the second image, among the plurality of second image capturing units.

Various embodiments will be described hereinafter with reference to the accompanying drawings.

### The First Embodiment

### In Case of Using Still Images

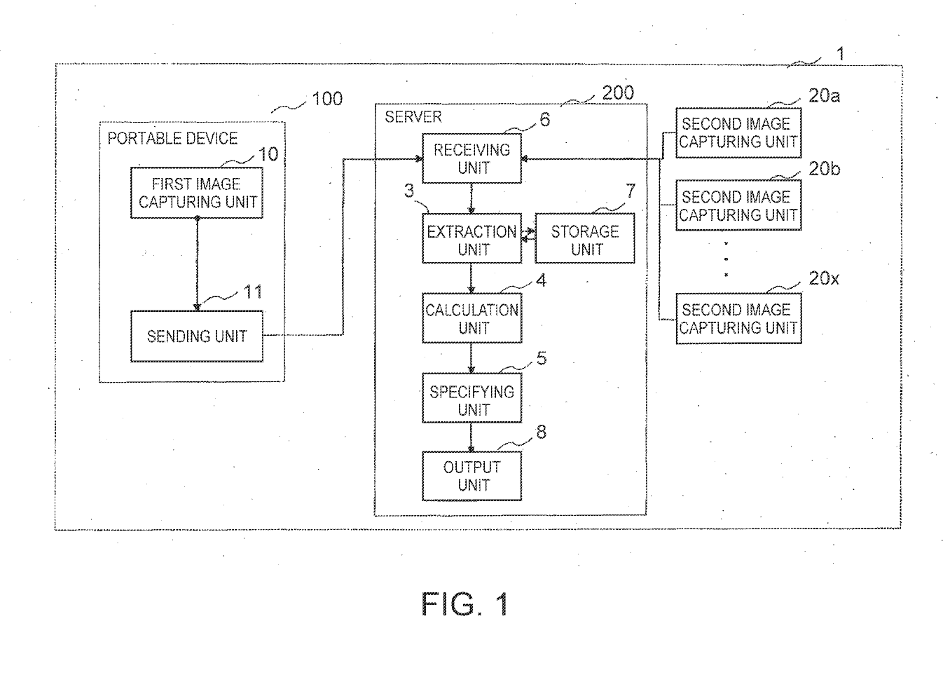

FIG. 1 is a block diagram showing one example of an image capturing unit-specifying system 1 according to the first embodiment. The image capturing unit-specifying system 1 includes a portable device 100, a server 200, and a plurality of second image capturing units 20a˜20x. The portable device 100 includes a first image capturing unit 10 and a sending unit 11. The server 200 includes an extraction unit 3, a calculation unit 4, a specifying unit 5, a receiving unit 6, a storage unit 7 and an output unit 8.

The portable device 100 includes a first camera (the first image capturing unit) 10 able to capture a still image (hereinafter, it is called “an image”), and the sending unit 11 to send the image to the server 200. The portable device 100 is connected to a network, and able to communicate with the second image capturing unit (explained afterwards). For example, a user is capturing the user oneself (himself or herself) by the first camera 10. This captured image (the first image) is sent to the server 200. Hereafter, an example that the user oneself is captured will be explained. However, a capturing target is not limited to the user oneself. For example, a plurality of users may be mutually captured. Namely, a person who is capturing a first image with the portable device 100 may be different from a user who is captured.

In the server 200, the receiving unit 6 receives images (captured by the first camera 10). The received images are sent to the extraction unit 3. Furthermore, the received images may be temporarily preserved in the storage unit 7.

A plurality of second cameras (the second image capturing units) 20a˜20X is located. For example, a plurality of surveillance cameras is located at one specific building or a plurality of specific buildings, and each surveillance camera is capturing an inside or a circumference of the building. More specifically, this camera can output a video signal. It may be a network camera connected via a network, or may be a plurality of analogue cameras to send a composite video signal. For example, a security system in which a plurality of cameras is cooperated may be used. Here, an example that the second camera 20a is capturing the user oneself will be explained. However, a capturing target is not limited to the user oneself. For example, a plurality of users may be mutually captured. Namely, a person who is capturing may be different from a user who is captured. The second camera 20a is capturing the user. This captured image (the second image) is sent to the extraction unit 3. Furthermore, identification information to correspond the second image with an ID of the second camera 20a is sent to the specifying unit 5. The second image may be temporarily preserved in the storage unit 7.

The extraction unit 3 extracts a first feature of the first image and a second feature of the second image. For example, a feature is extracted from each of face regions in the first image and the second images as the first feature and the second feature. The extracted features are sent to the calculation unit 4.

The calculation unit 4 calculates a similarity between the feature of the first image and the feature of the second image. The calculated similarity is sent to the specifying unit 5. For example, in case of the feature of the face region, a face of the first image is matched (compared) with a face of the second image.

If the calculated similarity is larger than a predetermined threshold, the specifying unit 5 specifies the second camera 20a which has captured the second image corresponding to the second feature. The predetermined threshold may be determined by previous training. By using the identification information (acquired from the second camera 20a) and the calculated similarity, the specifying unit 5 specifies the second camera 20a from a plurality of second cameras 20a˜20x.

The output unit 8 outputs a result specifying the second camera 20a. Information to correspond this result with an ID of the second camera 20a may be newly created from the plurality of second cameras 20a˜20x, and stored into the storage unit 7.

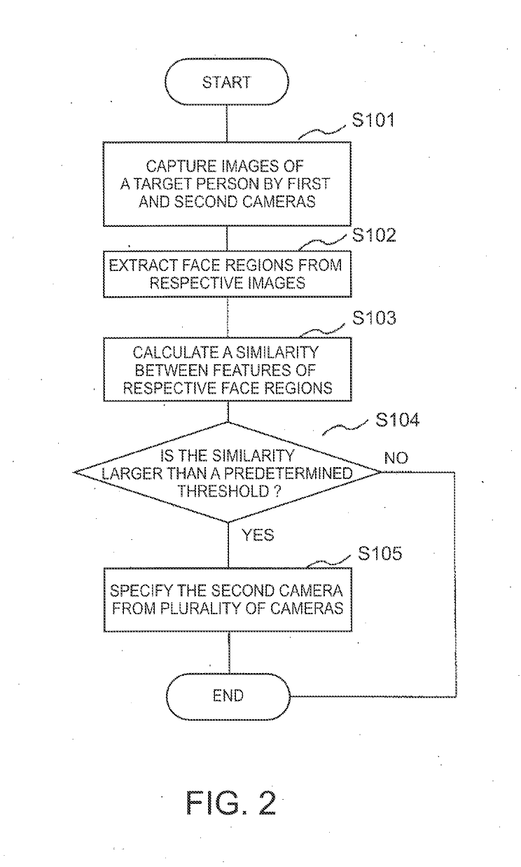

FIG. 2 is a flow chart of operation of the image capturing unit-specifying system 1 according to the first embodiment.

First, the first camera 10 and the second camera 20a capture the user respectively (S101). As a target captured by the first camera 10 and the second camera 20a, a person including a face region is preferred. For example, after an image of the user's face region is captured by the first camera 10 of the portable device 100, an image including the user's face region is captured by the second camera 20a while the user is opposing against a capturing direction of the second camera 20a.

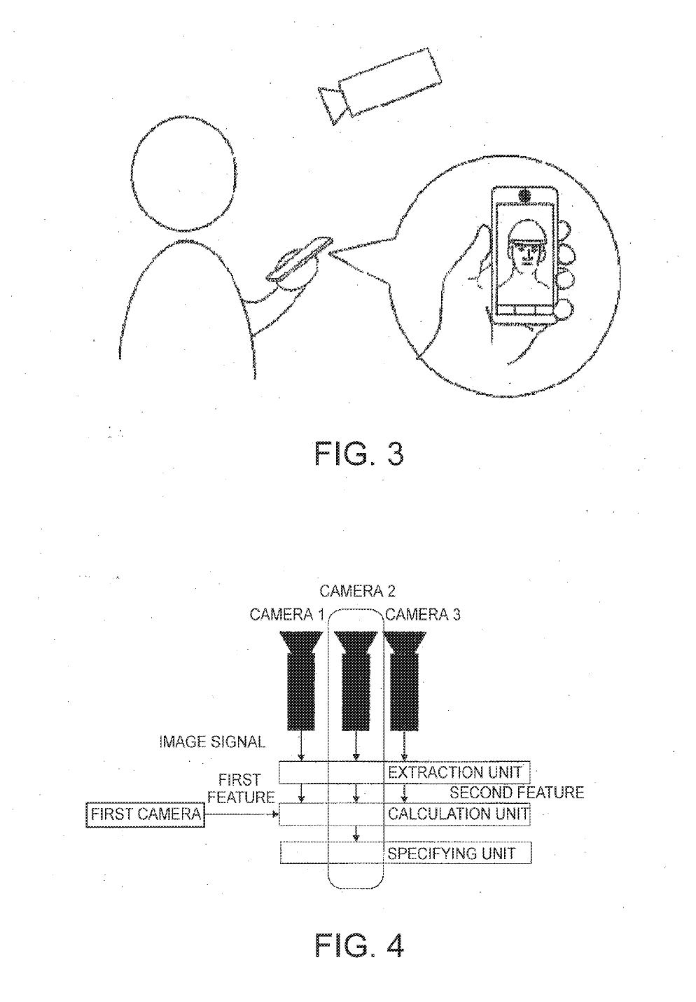

As the second camera 20a, a fixed surveillance camera is supposed. For example, the case that a person image including an operator's face is utilized will be explained by referring to FIG. 3. The user locates at a position where the user (as an object) can be captured in an angle of view of a surveillance camera to be selected, or the user locates at a position where the user can enter into the angle of view with his/her moving. First, an image including the user's face region is captured by the portable device 100. This face image is sent as the first (signature) information. On the other hand, by capturing the user with a specific surveillance camera, the same user's face image can be captured. This face image is the second (signature) information explained afterwards. The same user cannot exist at two positions simultaneously. Accordingly, by capturing the user or the same target person at least two times, a face image captured from the first camera 10 can be distinguished from a face image captured from the surveillance camera. Furthermore, if the same capturing area is shared among a plurality of surveillance cameras, the operator's face is often observed by the plurality of surveillance cameras. This case will be explained afterwards.

A type of the camera is not limited to the surveillance camera. Image-capturing by the second camera 20a may be performed at timing suitable for the user by using a remote controller. Furthermore, while the image capturing unit-specifying system 1 is being operated, the second camera 20a may capture an image at fixed intervals. Here, the fixed intervals are determined such as one image-capturing per one second, or one image-capturing per one minute. While the second camera 20a is capturing an image at fixed intervals, until the extraction unit 3 starts acquiring images, the captured images are temporarily preserved into the storage unit 7.

Next, the face region is extracted from respective images captured by the first camera 10 and the second camera 20a (S102). After the extraction unit 3 acquires a first image captured by the first camera 10, the extraction unit 3 acquires a second image captured by the second camera 20a from images preserved in the storage unit 7. Here, among times when respective images (preserved in the storage unit 7) are captured by the second camera 20a, a time when the second image is captured by the second camera 20a is the nearest to a time when the first image is captured by the first camera 10.

For example, detection of the face region is performed as follows. As to a pair of each pixel region on the acquired image, a difference (Harr-like feature) between pixel intensities of the pair is calculated. By comparing the difference with a threshold (determined by previous training), it is decided whether the face region is included in a notice region. Moreover, in order to evaluate correlation (co-occurrence) among a plurality of facial features, by combining threshold-comparison processing of a plurality of differences (Joint Harr-like feature) between pixel intensities, the face region can be decided with higher accuracy. By deciding a target region while changing a position and a size of the target region in the image, the position and the size of the face region may be detected.

In above-explanation, the face region was described as the example. For example, in case of a whole body of a person, a whole bode detector is previously trained and the corresponding body region is extracted by the detector. By using the face or the whole body of the person, a region to be matched can be necessarily specified. As a result, even if an image-capturing direction and a background of the first camera 10 are respectively different from those of the second camera 20a, the first camera 10 and the second camera 20a can be easily utilized.

Next, the calculation unit 4 calculates a similarity between features of respective face regions (S103). In case of utilizing a target region (such as a face image) explicitly decidable, the face recognition technique can be utilized. For example, if the image includes a whole body of a person, an equivalent region is extracted from the image, and a similarity thereof is calculated using the template matching technique. As a result of similarity-calculation, a second image having the similarity larger than a predetermined threshold is selected. An ID of the second camera 20a which has captured the selected second image is set to a candidate (Hereinafter, it is called “a selection candidate”).

Next, the specifying unit 5 specifies the second camera based on the similarity-calculation result (S104). In an example of FIG. 4, by extracting the second feature from video signals via a plurality of surveillance cameras and by comparing the second feature with the first feature, a similarity of the second feature extracted from a camera 2 is high, and sent to the output unit 8. As a result of comparison processing, the specifying unit 5 finally selects a camera from selection candidates of surveillance cameras each having the similarity larger than the threshold. If the selection candidate is only one, this one is selected. On the other hand, if a plurality of selection candidates exists, one selection candidate having the highest similarity is selected. Here, the number of surveillance cameras is not limited to one. Accordingly, among a plurality of selection candidates, selection candidates of which the number is predetermined may be selected in order of higher similarity. Alternatively, by sending selection candidates to the portable device, one surveillance camera may be finally selected from the selection candidates by an operator.

As mentioned-above, in the image capturing unit-specifying system 1, by matching an image sent from the portable device 100 with respective images captured from the surveillance cameras, one surveillance camera can be specified without measuring positions of the surveillance cameras. Specifically, by using information acquired from person-video information, the user can easily specify a position of this/her desired camera.

<In Case of Using Moving Images>

If dynamic images can be acquired by the first camera 10 and the second cameras 20a˜20x, information used by the extraction unit 3 and the calculation unit 4 may be features extracted from the moving images.

For example, feature vector (a set of features) using a moving and a posture of a specific part of the user's body may be utilized.

In this case, by detecting the specific part from the moving images acquired and by tracing a position of the specific part in time series, a coincidence degree between a locus of the position and a predetermined pattern can be used.

(The First Modification)

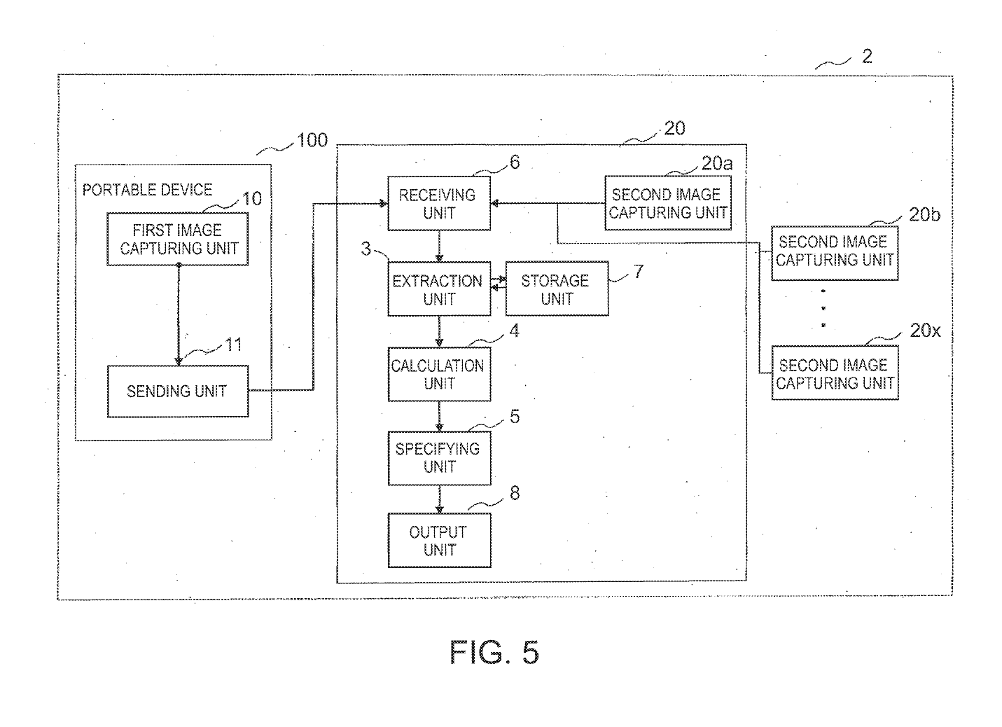

In the image capturing unit-specifying system 1 of the first embodiment, the second camera 20 is specified via the server 200. However, as shown in FIG. 5, the second camera 20 may include the receiving unit 6, the extraction unit 3, the calculation unit 4, the specifying unit 5, the output unit 8, and the storage unit 7. In this case, images captured by the second image capturing units 20b˜20x (except for the second image capturing unit 20a) are specified via the second camera 20. Operation thereof is same as that of the first embodiment.

(Hardware Component)

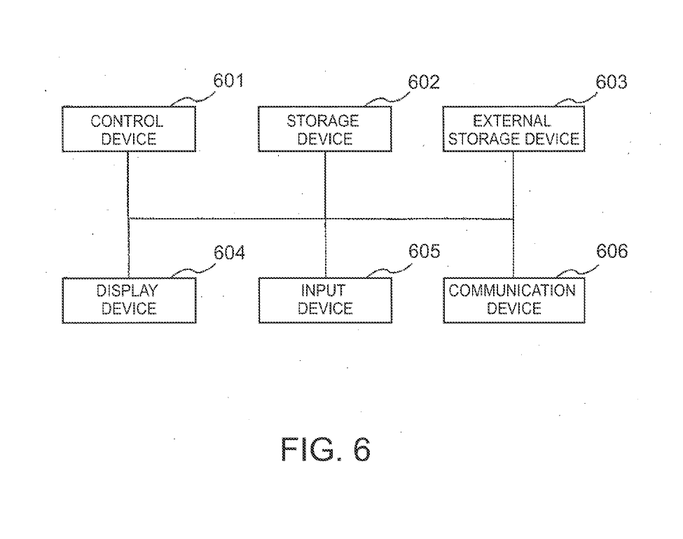

FIG. 6 is a block diagram of one example of hardware component of the image capturing unit-specifying system 1 of the first embodiment. As shown in FIG. 6, the system 1 equips a control device 601 such as a CPU, a storage device 602 such as a ROM (Read Only Memory) or a RAM (Random Access Memory), an external storage device 603 such as a HDD or a SSD, a display device 604 such as a display, an input device 605 such as a mouse or a keyboard, and a communication device 606 such as a communication I/F. The system 1 can be realized as hardware component using a regular computer.

A program executed by the system 1 is provided by previously being installed into the ROM. Furthermore, this program may be provided by being stored into a computer-readable storage medium (such as a CD-ROM, a CD-R, a memory card, a DVD, a flexible disk (FD)) as a file having an installable format or an executable format. Furthermore, this program may be provided by being stored into a computer (connected to a network such as Internet) and by being downloaded via the network.

In the first embodiment, the program executable by the system 1 comprises modules to realize above-mentioned each unit on the computer. As an actual hardware, for example, the control device 601 reads the program from the external storage device 603 to the storage device 602, and executes the program. As a result, above-mentioned each unit is realized on the computer.

As mentioned-above, in the first embodiment, by matching an image sent from the portable device with respective images captured from the surveillance cameras, one surveillance camera can be specified without measuring positions of the surveillance cameras. Specifically, by using information acquired from person-video information, the user can easily specify a position of this/her desired camera.

While certain embodiments have been described, these embodiments have been presented by way of examples only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, as to each step of the flow chart shown in FIG. 2, insofar as not contrary to the characteristic, an execution order of each step may be changed, a plurality of steps may be executed simultaneously, or each step may be executed in order different from FIG. 2 whenever the system being performed.

What is claimed is:

1. A system for specifying an image capturing unit, the system comprising:
a portable device including a first image capturing unit that captures a first image of a person, and a sending unit that sends the first image;
a plurality of second image capturing units that capture second images;
an extraction unit that extracts a first feature of the first image and a second feature of each of the second images;
a calculation unit that calculates a similarity based on the first feature and the second feature of the each of the second images; and
a specifying unit that, if the similarity for a second image is larger than a predetermined threshold, specifies a second image capturing unit that has captured the second image, among the plurality of second image capturing units.

2. The system according to claim 1, wherein
the first image capturing unit and the second image capturing unit capture a moving image of the person respectively,
the extraction unit extracts a position of the user's specific part in time series from the moving image, as the first feature and the second feature respectively, and
the calculation unit calculates a similarity between the first feature and a predetermined pattern, and a similarity between the second feature and the predetermined pattern.

3. The system according to claim 1, wherein
the portable device further includes a feature extraction unit that extracts the first feature of the first image,
the extraction unit extracts the second feature of the second image, and
the calculation unit acquires the first feature from the portable device and the second feature, and calculates the similarity based on the acquired first feature and the second feature.

4. The system according to claim 1, wherein
the portable device further includes a feature extraction unit that extracts the first feature of the first image captured by the first image capturing unit,
the extraction unit extracts the second feature of the second image captured by each of the second image capturing units, and
the calculation unit acquires the first feature from the portable device and the second feature, and calculates the similarity based on the acquired first feature and the second feature.

5. A method for specifying an image capturing unit, the method comprising:
capturing a first image of a person via a first image capturing unit;
sending the first image;
capturing second images via a plurality of second image capturing units;
extracting a first feature of the first image and a second feature of each of the second images;
calculating a similarity based on the first feature and the second feature of the each of the second images; and
if the similarity for a second image is larger than a predetermined threshold, specifying a second image capturing unit that has captured the second image, among the plurality of second image capturing units.

6. The method according to claim 5, further comprising:
extracting the first feature of the first image in a portable device;
wherein
the sending includes sending the first feature,
the extracting includes extracting the second feature of the second image, and
the calculating includes acquiring the first feature from the portable device and the second feature, and calculating the similarity based on the acquired first feature and the second feature.

7. The method according to claim 5, wherein
the capturing a first image and the capturing second images include capturing a moving image of the person respectively,
the extracting includes extracting a position of the user's specific part in time series from the moving image, as the first feature and the second feature respectively, and
the calculating includes calculating a similarity between the first feature and a predetermined pattern, and a similarity between the second feature and the predetermined pattern.

8. A non-transitory computer readable medium for causing a computer to perform operations for specifying an image capturing unit, the operations comprising:
capturing a first image of a person via a first image capturing unit;
sending the first image;
capturing second images via a plurality of second image capturing units;
extracting a first feature of the first image and a second feature of each of the second images;
calculating a similarity based on the first feature and the second feature of the each of the second images; and
if the similarity for a second image is larger than a predetermined threshold, specifying a second image capturing unit that has captured the second image, among the plurality of second image capturing units.

9. The non-transitory computer readable medium according to claim 8, the operations further comprising:
extracting the first feature of the first image in a portable device;
wherein
the sending includes sending the first feature,
the extracting includes extracting the second feature of the second image, and
the calculating includes acquiring the first feature from the portable device and the second feature, and calculating the similarity based on the acquired first feature and the second feature.

10. The non-transitory computer readable medium according to claim 8, wherein
the capturing a first image and the capturing second images include capturing a moving image of the person respectively,
the extracting includes extracting a position of the user's specific part in time series from the moving image, as the first feature and the second feature respectively, and
the calculating includes calculating a similarity between the first feature and a predetermined pattern, and a similarity between the second feature and the predetermined pattern.
